(19) United States
(12) Patent Application Publication
(10) Pub. No.: US 2015/0096161 A1
(43) Pub. Date: Apr. 9, 2015

(54) METHOD AND KIT FOR ADA COMPLIANCE OF VENDING MACHINES

(71) Applicant: Kevin C. Segebarth, Paducah, KY (US)

(72) Inventor: Kevin C. Segebarth, Paducah, KY (US)

(21) Appl. No.: 14/493,406

(22) Filed: Sep. 23, 2014

Related U.S. Application Data
(60) Provisional application No. 61/887,492, filed on Oct. 7, 2013.

(51) Int. Cl. G07F 9/10

(52) U.S. Cl. CPC G07F 9/10
USPC 29/401.1; 248/678

(57) ABSTRACT

A kit for modifying a vending machine having a plurality of interactive features includes a first riser and second riser having a predetermined height selected to raise the vending machine, a first connector shaped to concurrently engage a first opening of the first riser and a first portion of the vending machine, and a second connector shaped to concurrently engage a second opening of the second riser and a second portion of the vending machine. There is also a first plate having a shape and size to match an opening behind a first of the interactive features and a second plate having an opening matching outside dimensions of the first feature. Also, a cable is included having a first end matching a first complementary electrical connector of the first of the interactive features and a second end matching a second complementary electrical connector of control circuitry of the vending machine.

### RELATED APPLICATIONS

The present application claims priority to provisional patent application Ser. No. 61/887,492 entitled Method and Kit for ADA Compliance of Vending Machines, filed Oct. 7, 2013, the disclosure of which is incorporated herein by reference in its entirety.

### BACKGROUND

The present invention relates to an apparatus, kit and method for modifying the arrangement of input features on an existing vending machine.

Vending machines are commonly used to dispense various food and drink items according to a user's selection of the item in return for payment. Vending machines typically have the shape of a three-dimensional rectangular prism with a plurality of faces or sides including a front face/side, a back face/side and two lateral sides/faces (and a top and bottom). The front face of these vending machines may typically be divided into portions including a main portion, a bottom portion and/or a side panel portion. The main portion may generally be the largest in surface area and display advertising words or images, food or drink options and may possibly include buttons or other inputs for the selection of items to be dispensed. The main portion may also include a transparent window for direct product display and selection. The main portion may extend from at or near the top of the machine to at or near the bottom of the machine, or it may extend from at or near the top of the machine to an intermediate level if a bottom portion is present between the top main portion and the bottom of the machine.

The side panel portion of the vending machine may include various product or item selection input(s), such as a button(s), keypad(s), etc., especially if such item selection input(s) are not present on the main portion. The side panel portion may also include one or more payment input(s), such a bill acceptor, coin acceptor, credit card acceptor, etc., or any combination thereof; as well as other possible feature(s), such as a door lock. The side panel portion may often have a vertical arrangement and positioning of these various input(s), etc., within the side panel portion near one of the lateral sides of the vending machine. However, a vending machine may not have a separate side panel portion, and/or a side panel portion may be integrated with, and/or part of, the main portion. Indeed, the side panel portion may simply a part of the main portion of a vending machine near one of its lateral sides.

To access the interior of the vending machine to refill or provide maintenance or repair of the machine, much or all of the front side or face of the vending machine may also be part of a side hinged door that can be opened from near one of the lateral sides of the machine if unlocked. This door may include the main portion of the machine alone or perhaps in combination with the side panel portion of the machine. A product opening is also typically present in a lower part of the main portion or the bottom portion of the front side or face of a vending machine where the dispensed item or product may be made available to the user or consumer following their item/product selection and/or payment.

The Americans with Disabilities Act (ADA) has recently imposed restrictions on the placement of the various inputs for item selection and payment as well as the placement of the product opening on vending machines, such that disabled people in wheelchairs may be able to comfortably reach those various item selection/payment inputs and the product opening on the machine from a seated position in the wheelchair. Basically, these regulations require vending machines to have these various inputs and the product opening to be positioned within a range of heights of the ground (i.e., not too low or too high) easier accessed by disabled persons. More specifically, these new regulations require that these input and dispensing features of vending machines be at least above 15 inches but below 48 inches. However, many existing vending machines do not meet these new ADA requirements.

Therefore, a need exists in the art for a novel method and kit for the conversion of existing vending machines to meet these new requirements that is economical and does not require the expensive replacement of major portions of these machines.

### SUMMARY

Embodiments of the present invention relate to a kit for modifying a vending machine having a plurality of interactive features that includes a first riser and second riser having a predetermined height selected to raise the vending machine, a first connector shaped to concurrently engage a first opening of the first riser and a first portion of the vending machine, and a second connector shaped to concurrently engage a second opening of the second riser and a second portion of the vending machine. There is also a first plate matching an opening behind a first of the interactive features and a second plate having an opening matching outside dimensions of the first feature. Also, a cable is included having a first end matching a first complementary electrical connector of the first of the interactive features and a second end matching a second complementary electrical connector of control circuitry of the vending machine.

Another embodiment of the present invention relates to a method of modifying a vending machine having a plurality of interactive features that includes determining a maximum height from a ground level, above which none of the interactive features are to be located after modifying the vending machine; and determining a minimum height from the ground level, below which none of the interactive features are to be located after modifying the vending machine. The method also includes physically altering the vending machine to raise at least one of the interactive features above the minimum height and lower at least a second of the interactive features below the maximum height.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of a embodiments of the disclosure are illustrated by way of example, and not by way of limitation, in the accompanying drawings, wherein:

FIG. 1 is a front view of a prior art vending machine;

FIGS. 2A and 2B illustrate features of a vending machine modified in accordance with the principles of the present invention;

FIGS. 3A-3D illustrate various elements of a kit for modifying vending machines in accordance with the present invention.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

Embodiments of the present invention relate generally to a kit and method for the conversion of existing vending machines to meet newer height requirements for the various product/item selection input(s), payment input(s), and product dispensing opening(s) on the machine. Embodiments of the present invention also relate to the modified vending machines made or produced thereby. For purposes of the present invention, a “vending machine” may include any machine as commonly understood that dispenses an item or product (the item/product becoming accessible through a product opening on the machine) in response to a selection of the item/product and/or receipt of a form of payment from a consumer or user, which may also be modified according to any kit and/or method of the present invention as described herein.

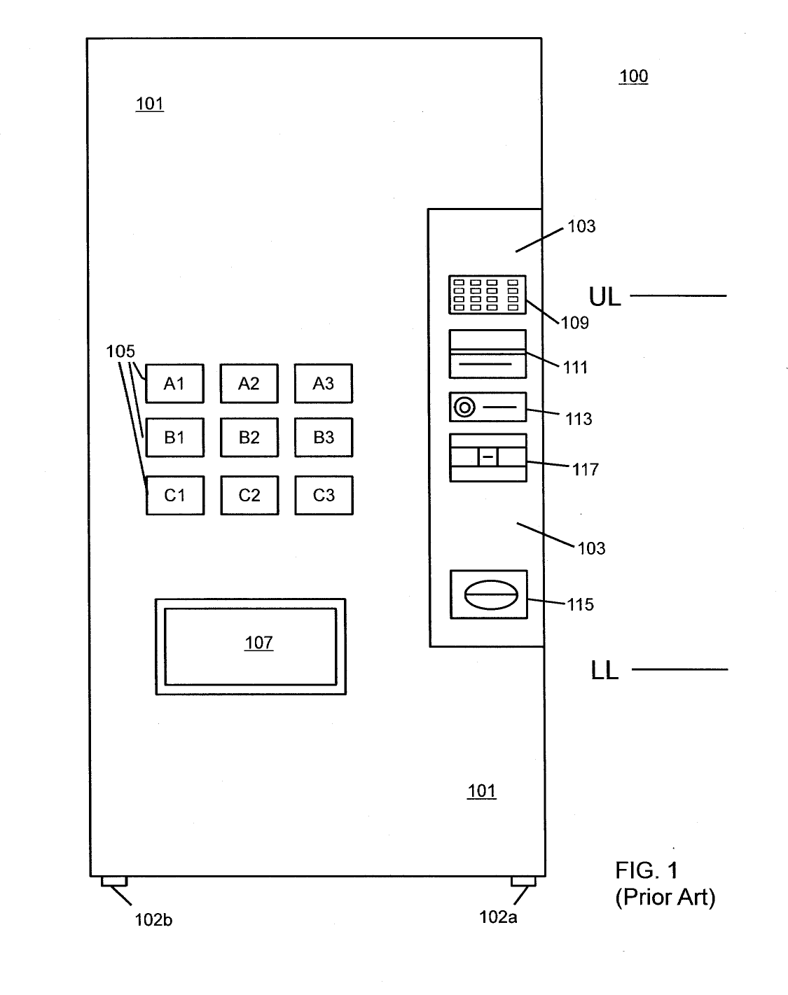

FIG. 1 shows an example of a vending machine 100 viewed at its front side or face. The front side or face of the vending machine 100 is shown having a main portion 101 and a side panel portion 103. Within the main portion 101 are a plurality of product option displays 105 and a product dispensing cavity and opening 107 (i.e., a product opening) for the user or consumer to access the dispensed product following their selection and payment. With this example of a vending machine 100, the side panel portion 103 includes a keypad 109 for entry of a product selection, such as according to unique letters and/or numbers associated with each of the product choices 105 displayed on the main portion 101. According to this example, the side panel portion 103 also has additional features for payment, such as a bill acceptor 111, a coin acceptor 113, and a change or coin return 115. A lock 117 is also shown in the side panel portion 103 for unlocking and opening a front door of the vending machine comprising the main portion 101 and/or the side panel portion 103 to access the interior of the machine 100.

Due to new ADA regulations, many existing vending machines may have features requiring physical interaction, input, etc., by a user/consumer of the machine to select, purchase and/or access a dispensed product (collectively, “interactive features”). These interactive features on a vending machine may include product selection input(s), payment input(s), payment or coin return(s), and product opening(s) for receiving the selected product(s), etc., one or more of which may be positioned (in whole or in part) too high or too low off the ground on these existing machines (i.e., outside the required range of heights for comfortable access by a disabled person seated in a wheelchair).

One of ordinary skill will recognize that design constraints other than specifically complying with the ADA could impose a desired maximum height and/or minimum height for interactive features of a vending machine. Thus, while the present disclosure describes aspects of the present invention with relationship to the ADA regulations, the components, methods and kits described herein can be used to modify existing vending machines in a way that do not necessarily result in conformance with the ADA regulations but, rather, conform to some other desirable design standard.

For example, an upper limit (“UL”) and a lower limit (“LL”) are shown with lines in FIG. 1 to depict a conceptual range of allowed heights for these interactive features requiring physical and/or manual interaction by a user or consumer. As also shown in the example of FIG. 1, a couple of interactive features of the vending machine are positioned outside the acceptable ranges of heights (i.e., between LL and UL), namely the keypad 109 is positioned at least partially above the upper limit (UL) and the product opening 107 is positioned at least partially below the lower limit (LL) in FIG. 1.

Therefore, to make the vending machine in FIG. 1 compliant with ADA regulations, the keypad 109 would have to be lowered while the product opening 107 would have to be raised. However, it is challenging to concurrently raise and lower two different features on the machine that are separated by a fixed spatial distance without replacing the entire front of the machine. Thus, two separate methods and/or sets of kit components are proposed specifically for the purpose of raising and/or lowering these interactive features of vending machines as needed to comply with ADA height regulations.

According to a first major aspect of the present invention, a method and kit are provided and proposed for raising one or more interactive feature(s) of an existing vending machine that is/are positioned at least partially or wholly below the lower regulatory height limit (e.g., LL in FIG. 1). The amount or distance these interactive features must be raised off the round depends on how far the lowermost portion of the non-compliant interactive feature(s) is/are below the lower regulatory height limit. Thus, it is proposed that the vending machine as a whole may be raised off the ground according to this first major aspect of the present invention by placing one or more riser(s) (preferably at least two risers) underneath the vending machine to lift it (and its interactive features) further off the ground. The height dimension of the riser may depend on the amount or distance a vending machine to be modified needs to be raised off the ground to comply with these requirements. In addition, one or more adjustable “legs” may also be attached to the risers to vary the amount or distance that the vending machine may be raised with a particular riser(s). Thus, in addition to riser(s), a kit according to the major aspect of the present invention may also include leg(s) (preferably two or more legs). For example, these legs may comprise a foot portion at one end that contacts the ground and a threaded stem portion for adjustably engaging and attaching to the riser(s) and may be the same or similar to existing leveler legs often used at the base of machines, furniture, etc. Alternatively, one or more of the legs may already be present and attached to a base of the existing vending machine (see, e.g., legs 102 in FIG. 1) and may thus be removed and attached, etc., instead to the riser(s) placed underneath the machine.

Each of the risers of the present invention used to raise an existing vending machine may have a generally elongated shape having a length, height and width dimensions. The height and width dimensions of a riser are generally oriented perpendicular to the length dimension of the riser along its elongated or longitudinal axis. When placed underneath and/or attached to an existing vending machine, a riser will be oriented with its height dimension being between the vending machine and the floor or ground and its length dimension oriented generally or approximately in a front-to-back direction in relation to the front and back of the vending machine. Each of the riser(s) may have one or more hollow or tube-like portion(s), cavity/cavities, etc., extending some, most or all of its length, which may allow for access into the interior of the riser, which may facilitate the attachment of one or more fastener(s), leg(s), etc., to the riser before or during installation, such as during the construction or manufacturing of the riser. These hollow portion(s) of each riser may thus have two spaced apart side walls spanning between a top and a bottom wall. The risers may generally be made of a strong material to withstand the forces and weight involved during use, such as steel, etc. The dimensions of each of the risers may generally have a length that approximates most or all of the depth of the vending machine (between its front and back sides), or at least a base of the vending machine (e.g., about 2-5 feet). The riser may also vary in width, but may be in a range of about 3-4 inches. The height of the riser may also vary, but may be in a range of about 2-3 inches.

The one or more fastener(s), leg(s), etc., attached to the riser may be used to (i) attach the riser to a portion of the existing machine, such as to a base of the frame of the machine, by one or more fastener, to adjust the height of the machine by adjusting the one or more leg(s) attached to the riser, etc. Thus, one or more leg(s) may be attached to the riser by insertion and/or engagement with one or more hole(s) in the bottom of the riser, such as a hole through a bottom wall of the riser, which may be inwardly threaded to match the outer threads of the leg(s).

As stated above, each of these legs may be taken from the bottom of an existing machine and repurposed and moved to the lower side of the riser, or these leg(s) may be part of the kit with the riser(s) and newly installed.

An additional fastener(s) may also be attached to the riser by insertion and/or engagement with one or more hole(s) in the top of the riser, such as a hole through a top wall of the riser, which may be inwardly threaded to match the outer threads of the corresponding fastener. As an example, a threaded stem of the fastener (e.g., of a standard bolt or similar fastener or a “headless” threaded fastener) may be screwed into a threaded hole in the top of the riser. Alternatively, the hole may not be sized to match the size of the fastener(s)—i.e., the fastener may have a stem portion with a smaller diameter than the diameter of the corresponding hole of the riser. In such a case, the head of the fastener may be large enough and/or one or more washers or the like may be used, such that the fastener inserted into such a corresponding hole (with a larger diameter) can be secured in place against a portion or wall of the riser surrounding the hole. Such a fastener may typically include a bolt or similar fastener having a head portion and a threaded stem portion that may be attached to the riser perhaps in conjunction with one or more washers. Such a fastener may also be additionally and fixedly attached and secured to the riser by any additional suitable means, such as gluing, welding, soldering, brazing, etc. For example, such a fastener may be inserted upward through a hole in a top wall of the riser from within an interior hollow cavity of the riser with the head of the fastener positioned below the hole in the top wall (i.e., within the interior cavity of the riser). In this case, the fastener and/or its associated washers, etc., may also be fixedly attached to the top wall of the riser by any suitable means, such as by welding, etc.

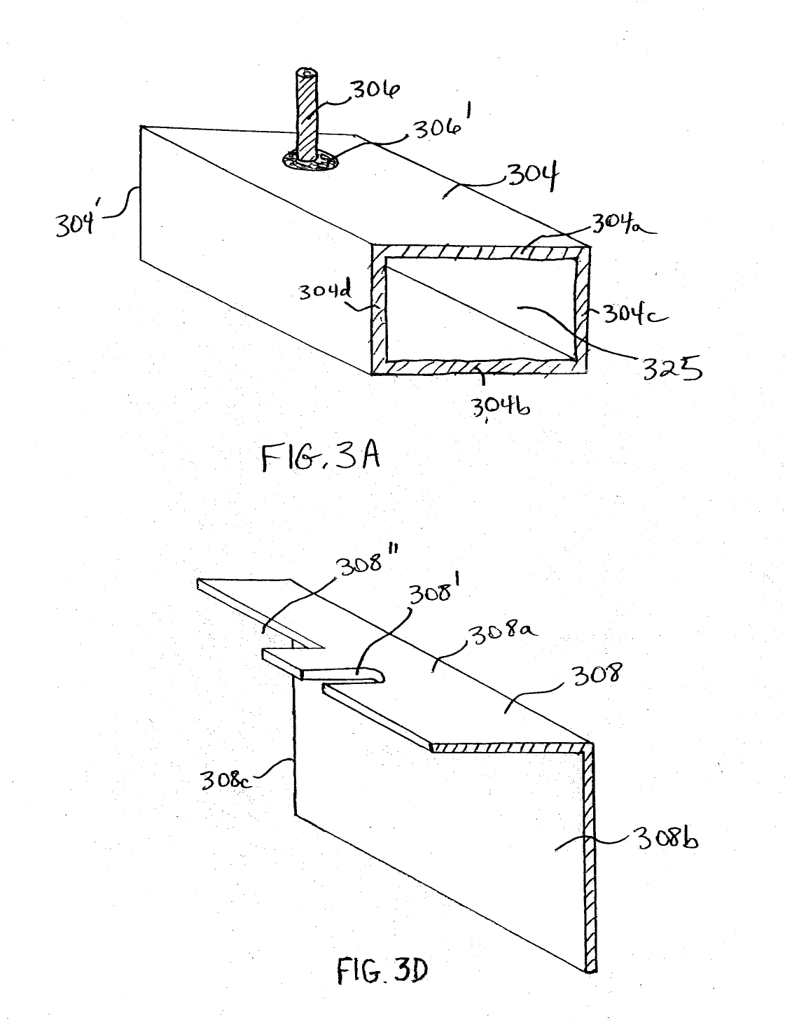

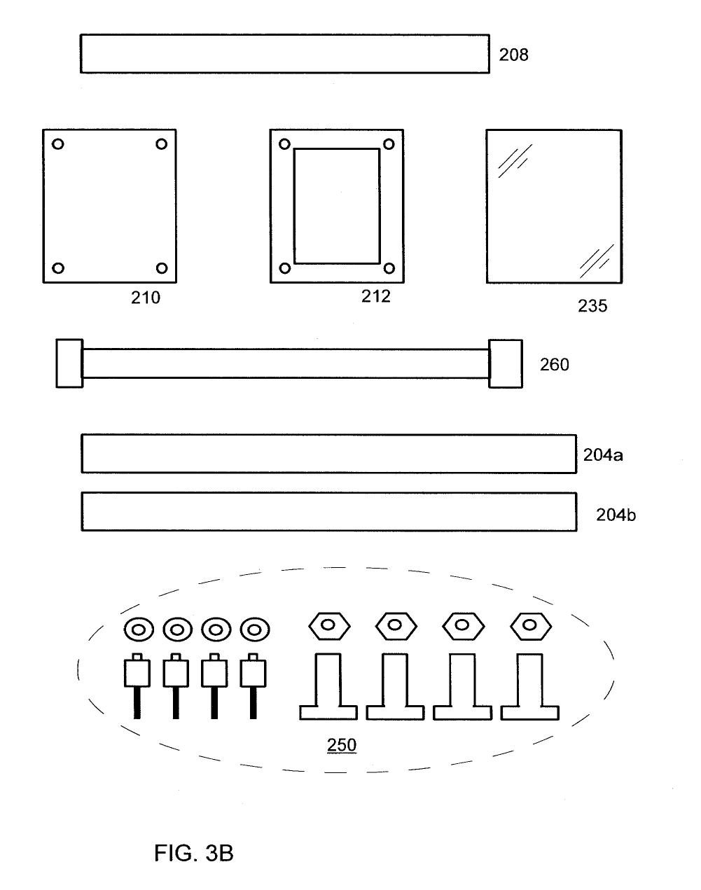

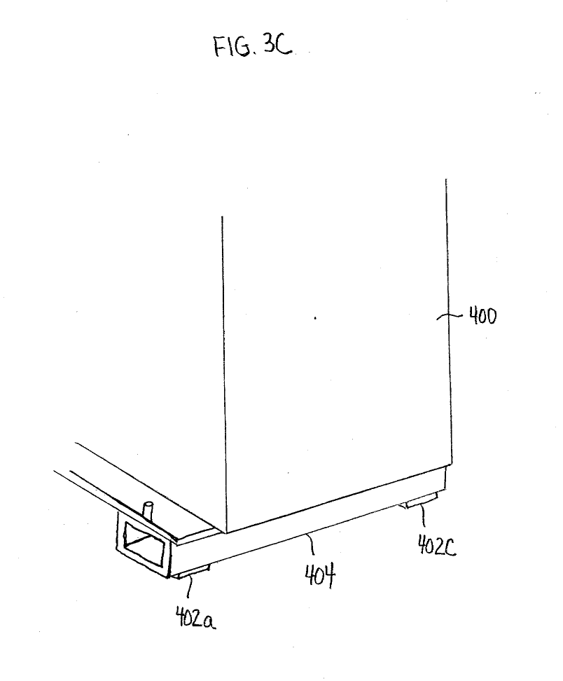

As shown for example in FIG. 3A from a perspective, cross-sectional view, a riser 304 having a top wall 304a, a bottom wall 304b and two lateral side walls 304c, 304d, may have a hole 306′ through the top wall 304a near a first end 304′ of the riser 304. A cavity 325 is also shown inside the riser 304, which may be used to facilitate the insertion and attachment of fasteners through a hole(s) in the riser. As stated above, the fastener 306 may have a head surface (perhaps in addition to one or more washers) that may be fused, bonded, welded, etc., to the inner surface of the top wall 304a. An image of a riser positioned below a modified vending machine is also shown in FIG. 3C. As shown in that figure, a riser 404 is positioned underneath a base portion of the modified vending machine 400. The riser 404 is attached to the machine by one or more fasteners 406 attached to the top wall of the riser 404 through a hole in the base portion of the machine. Additional accessories, such as a nut, washer(s), etc., may also be used to secure the fastener(s) 406 to the base portion of the modified vending machine. Two legs 402a, 402c are also shown attached to the underside and bottom wall of the riser 404 near the front and back ends of the riser 404.

In any case, regardless of the exact construction of the fastener used for this purpose, its manner of attachment, or whether or not it is fixedly attached to the riser by such an additional means, the fastener will generally be positioned such that it has an elongated stem portion extending upward through the hole and above the top wall of the riser. Thus, this upwardly extended portion of the fastener may be used in securing, attaching, etc., the riser to the vending machine, such as to a base portion of the frame of the vending machine.

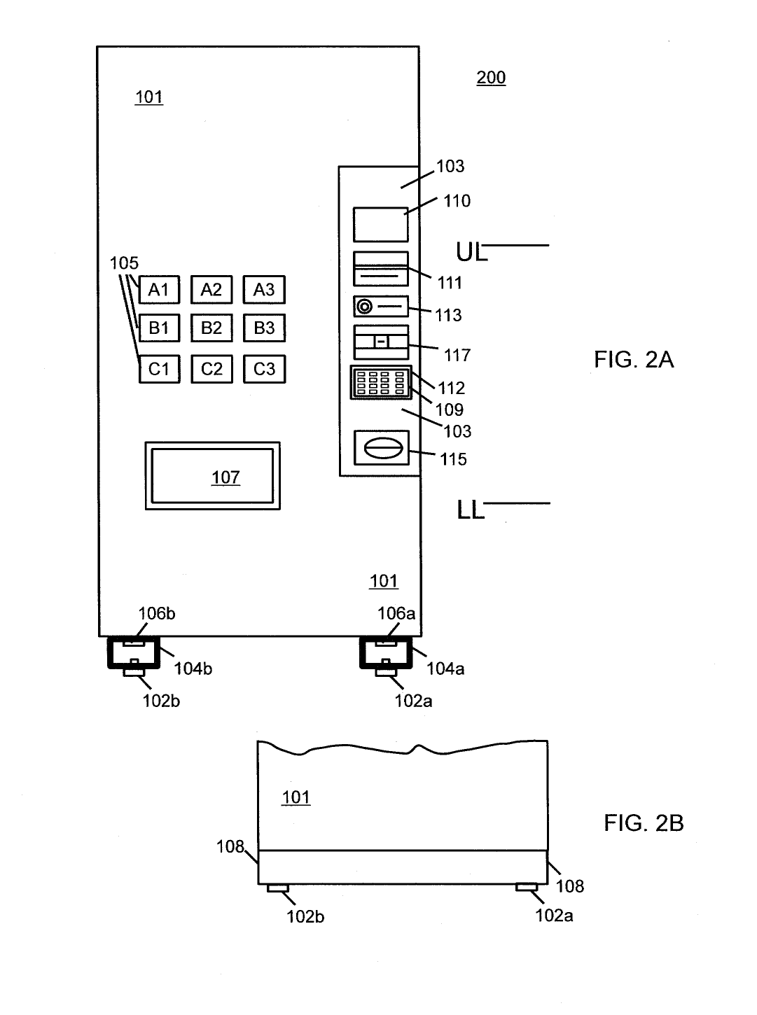

An example of a modified vending machine 200 according to an embodiment of the present invention is shown in FIG. 2A. This vending machine 200 is a modification of the example of an existing vending machine 100 shown in FIG. 1. As can be seen in the embodiment of the present invention shown in FIG. 2A, two risers 104a, 104b are placed underneath the bottom of the vending machine to raise it further off the ground. In this example, the legs 102a, 102b that were present under the vending machine 100 in FIG. 1 are removed and reattached to the bottom of the respective risers 104a, 104b. However, the legs may instead be newly supplied. Each of the risers 104a, 104b is also shown attached to a base of the frame by insertion and attachment of one or more fasteners 106a, 106b that are also attached to the risers. As further shown in FIG. 2B, an additional kick plate, cover plate or skirt 108 may be placed in front of the risers spanning the space between the main portion 101 of the front of the modified machine 200 and the ground to cover the presence of the risers 104a, 104b and thus make the machine have a better appearance and aesthetics. As a result of lifting the vending machine 200 further off the ground by a method and kit of the present invention, the product opening 107 that was previously partially below the lower regulatory limit LL in the example of FIG. 1 is now positioned above this lower limit and thus in compliance with the height requirements.

The risers 104a, 104b are depicted in FIGS. 2A and 2B as having their longitudinal axis extending in a direction between the front of the machine 200 and the back of the machine 200. However, the risers 104a, 104b could also be sized and oriented to extend between a right side of a vending machine and its left side. Thus, one riser could be placed along the underside of the front of the machine and the other placed along the underside of the back of the machine. Similarly, more than two risers could be used such as three risers with one substantially underneath the middle of the machine or four risers with one positioned at each corner of the machine.

The cover plate or skirt 108 used to cover the front of the risers placed underneath the vending machine may have an L-shape in cross section along its length with a front facing portion and a top facing portion. The front facing portion may perform the function of aesthetically shielding the risers, whereas the top facing portion may be used to secure the cover plate to the modified vending machine. For example in FIG. 3D, a cover plate 308 is shown in perspective cross-sectional view having a top facing portion 308a and a front facing portion 308b. An inlet or cut-out 308′ is further shown in a back end of the top facing portion 308a. Another inlet(s) may be positioned elsewhere on the cover plate, at least one of which may be placed symmetrically or otherwise near the opposite longitudinal end of the cover plate. Such an inlet 308′ may be positioned and used to receive the fastener(s) used to secure, attach, etc., a respective riser to the vending machine by the tightening of such fastener(s). Another similar inlet may also be positioned near the opposite end of the cover plate for attachment to the fastener of another riser near the opposite lateral side of the vending machine. Other cut-outs are also possible to accommodate different obstacles or structures that may be present, such as cut-out 308″ near one end 308c of the cover plate on the back side of the top facing portion.

When the vending machine 200 is modified by being raised with the risers 104a, 104b and the legs 102a, 102b, if there are one or more interactive feature(s) of an existing vending machine (to be modified) positioned at, near or above the upper limit, then raising the vending machine will not bring these interactive feature(s) into compliance (i.e., below the upper limit). In fact, interactive feature(s) of the vending machine positioned at or near the upper limit (before the modification to raise the vending machine) may actually be lifted from a position below the upper limit to a higher position above the upper limit and thus out of compliance.

Thus, according to another aspect of the present invention, methods and kits are provided and proposed for selectively relocating one or more interactive features to a lower position on the vending machine. If those interactive feature(s) are already positioned at least partially above the upper limit, or if they are positioned at a height close enough to the upper limit that they will become raised at least partially above the upper limit upon raising of the vending machine, then that interactive feature(s) may be selectively relocated to a lower position on the vending machine to make sure they remain, or result in becoming, in compliance with the height requirements of ADA regulations or other design guidelines. According to many embodiments, such interactive feature(s) may be positioned at a lower position on the portion of the front side of the machine on which it was previously located (e.g., from an upper position on the side panel portion to a lower position on the side panel portion). As a combined result of raising the entire machine and lower certain interactive features, the lower interactive feature(s) of a modified vending machine become positioned above the lower limit, whereas the upper interactive feature(s) of the modified vending machine become positioned below the upper limit. Thus, the modified vending machine produced thereby is fully in compliance with the height requirements of ADA regulations or other design guidelines.

Thus, according to embodiments of the present invention, kits are provided that may include a plurality of the components and pieces described herein. Such kits of the present invention may comprise a plurality of components, parts, fasteners, accessories, etc., that may be needed for raising an existing vending machine and lowering interactive features, or a combination thereof, which may depend on the vending machine to be modified.

An example of a collection of such components and parts are shown in FIG. 3B showing two risers 204a, 204b; a cover plate 208; an electronic ribbon 260; a full plate 210; an open plate 212; and a template 235. The risers 204 and the cover plate 208 were already described above. It is worth further noting that the example of a cover plate 208 shown in FIG. 3B shows two inlets in the top facing plate of the cover plate for receiving fasteners used to attach two spaced-apart risers to a modified vending machine. The full plate 210 may be used to cover the hole left by the relocation of the keypad 109 or other interactive component from the upper position, and the open plate 212 may be used to secure the keypad 109 or other interactive component at the new, relocated lower position.

According to the examples in FIGS. 1 and 2, a keypad 109 is shown relocated from an upper position to a lower position on a side panel portion of a vending machine. Thus, a full panel (See FIG. 2A element 110 or FIG. 3B element 210) can be used to cover the hole or opening left by the removed keypad 109. To hold the keypad 109 at its new lower position, an open plate (112 or 212) can be used. The keypad 109 is placed with its back flush against the front surface of the side panel portion at its new lower position. To hold the keypad in place, the inner edges of an opening in the open plate 112 may rest against and engage a lip on the keypad around the periphery of the keypad area to sandwich the lip between those inner edges of the open plate and the front surface of the side panel portion. Because the keypad 109 is placed in front of (i.e., on the outside of) the side panel portion of the vending machine at its new location, a larger hole or opening on the front of the side panel portion is not needed to present the keypad 109. Instead, only a small hole, opening or slit may be needed to receive an electronic ribbon (see, e.g., 260 in FIG. 3B) through it that connects the keypad to inner circuitry, etc., of the machine (i.e., to communicate the user selection inputs appropriately to the machine). The ribbon may be longer to account for the greater distance it must reach from the new lower position to the appropriate input. The length of the cable 260 can vary such as, for example, being 1 foot, 2 feet, 3 feet, or longer, in length.

In contrast, the keypad 109 at its previous upper position on the side panel portion may have been behind the front of the side panel portion 103. Thus, a larger opening may have been present at that upper position to allow for the keypad to be placed within it. A full plate may thus be provided to cover the hole left by the removal and relocation of the keypad 109. A template 235 may also be provided to guide an installer on where to drill holes for attaching the full or open plate(s) to the vending machine (i.e., for the insertion of fasteners, such as pop rivets, etc.) through corresponding small holes in the plates and front of the machine. Various small fasteners and accessories 250 may also be provided.

According to another aspect of the present invention, methods are provided for modifying an existing vending machine. Such a method may comprise the steps described herein for carrying out the modifications of an existing vending machine according to concurrently raising and lower interactive features of the vending machine. Thus, in addition to the above, a method of the present invention may generally include steps relating to the placement of spaced-apart riser(s) underneath a vending machine, such as near respective lateral sides of the vending machine, and attaching, etc., those risers to the vending machine. These steps may include the insertion of one or more fasteners into holes in the top of the riser(s), or those fasteners may have already been attached (e.g., fixedly attached). The attachment of legs to a lower part of the risers may also be included, which may be performed prior to placement of the riser(s) underneath the vending machine. This method may also include steps relating to the attachment of a cover plate to the vending machine in front of the attached risers.

Other method in accordance with the principles of the present invention described above may include steps relating to the selective repositioning or lowering of interactive feature(s) from a first (upper) position at, near or above an upper regulatory limit to a second (lower) position within the required height range. Such methods may further include the covering by attachment of a plate, etc., of any hole, opening, etc., that may have been left behind by the removal of the interactive feature from its prior first (upper) position. Such methods may also include steps not only for removing the interactive feature(s) from their first upper position(s) on the vending machine, but also steps for attaching those interactive feature(s) to their new, second (lower) position(s) on the vending machine, which may involve steps of drilling new holes and the use of various fasteners or other accessories. Such methods may also include steps of properly reconnecting any of the relocated input(s), etc.

While modification of a vending machine has been described herein with respect to a specific example, one of ordinary skill will recognize that various modifications may be made without departing from the scope of the present invention. For example, the risers that are used may be of a predetermined size to match a vending machine that is intended to be modified. Thus, a modification kit such as shown in FIG. 3B may always include a plurality of risers 204a, 204b but the specific size of the riser to include in the kit may vary depending on the vending machine to be modified. Alternatively, the risers 204a, 204b may be telescopic in nature such as each riser being made in a plurality of sections that telescope within one another to create a riser having a variable length that can be determined by an installer at the time of modifying a machine.

Also, more than one full plate and more than one open plate may be provided to accommodate different sized, and different numbers of, interactive features. For example, multiple full plates and open plates of different sizes and shapes may be provided. As another example, the open plate 212 may have cross-sectional shape to accommodate the keypad 109 so that an inside surface of the open plate is substantially flush with the outside surface of the vending machine once the keypad 109 has been relocated behind the open plate 212. Different spacers and plate thicknesses can be included in a kit to accommodate interactive features having thicknesses different than the keypad 109, for example. Also, one or more ribbon cables 260 can be included to accommodate other interactive features as well. For example, multi-conductor cables along with various electrical connectors known to be popular in the vending machine industry can be included in the kit so that an installer can potentially custom-fabricate a cable from the kit components in order to accommodate relocating a variety of interactive features. As another alternative, ribbon cables 260 of different lengths could be included in the kit, or could be constructed by the installer from the kit components, to accommodate moving an interactive feature various distances from its original location.

While the present invention may have been disclosed with reference to certain embodiments, it will be apparent that modifications and variations are possible without departing from the spirit and scope of the invention as defined herein. Furthermore, it should be appreciated that any and all examples in the present disclosure, while illustrating embodiments of the invention, are provided as non-limiting examples and are, therefore, not to be taken as limiting the various aspects so illustrated. The present invention is intended to have its full scope consistent with the description herein, and equivalents thereof. Accordingly, the drawings and description are to be regarded as illustrative and not as restrictive.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of modifying a vending machine having a plurality of interactive features, comprising:
determining a maximum height from a ground level, above which none of the interactive features are to be located after modifying the vending machine;
determining a minimum height from the ground level, below which none of the interactive features are to be located after modifying the vending machine; and
physically altering the vending machine to raise at least one of the interactive features above the minimum height and lower at least a second of the interactive features below the maximum height.

2. The method of claim 1, wherein the maximum height and the minimum height are specified by governmental regulations related to disabled persons.

3. The method of claim 1, wherein physically altering the vending machine comprises:
raising the vending machine a first distance so that a lowest feature of the interactive features is positioned above the minimum height; and
relocating a highest feature of the interactive features down a second distance so that the highest feature is positioned below the maximum height.

4. The method of claim 3, wherein after relocating the highest feature, the highest feature is no longer above all of the other interactive features.

5. The method of claim 3, comprising:
installing a cover over an opening at an original position of the highest feature.

6. The method of claim 3, comprising:
creating an opening in a front surface of the vending machine substantially near where the highest feature is relocated; and
electronically connecting the highest feature to internal controls of the vending machine using an electrical conductor that passes through the opening.

7. The method of claim 3, wherein raising the vending machine comprises:
coupling a first riser to one side of the vending machine; and
coupling a second riser to another side of the vending machine.

8. The method of claim 7, comprising:
connecting a cover plate along a front of the vending machine in a manner that obscures visibility of the first and second riser when the vending machine is viewed from the front.

9. The method of claim 3, wherein:
the lowest feature comprises a dispensing opening.

10. The method of claim 3, wherein:
the highest feature comprises a selection keypad.

11. A kit for modifying a vending machine having a plurality of interactive features, comprising:
a first riser having a predetermined height selected to raise the vending machine a predetermined amount;
a second riser having the predetermined height;
a first connector shaped to concurrently engage a first opening of the first riser and a first portion of the vending machine;
a second connector shaped to concurrently engage a second opening of the second riser and a second portion of the vending machine;
a first plate having a shape and size to match an opening behind a first of the interactive features;
a second plate having an opening with a shape and size that matches outside dimensions of the first of the interactive features; and
a cable having a first end matching a first complementary electrical connector of the first of the interactive features and a second end matching a second complementary electrical connector of control circuitry of the vending machine.

12. The kit of claim 11, wherein:
the first riser includes a third opening sized to engage a first leg; and
the second riser includes a fourth opening sized to engage a second leg.

13. The kit of claim 12, comprising:
the first leg and the second leg.

14. The kit of claim 13, wherein a first length of the first leg is variable and a second length of the second leg is variable.

15. The kit of claim 12, wherein each of the first riser and the second riser are rectangular tubes and:
the first opening and the third opening are on opposing sides of the first riser, and
the second opening and the fourth opening are on opposing sides of the second riser.

16. The kit of claim 11, wherein the first portion and the second portion are at opposite sides on a bottom of the vending machine.

17. The kit of claim 11, comprising:
a coverplate having a height substantially the same as the predetermined height and a length based on a width of a front of the vending machine.

18. The kit of claim 11, wherein the predetermined height is based on a position of a lowest feature of the plurality of interactive features.

19. The kit of claim 18, wherein the predetermined height, when the first and second risers are attached to the vending machine, is effective to raise the position of the lowest feature above a predetermined minimum height from a ground level.

20. The kit of claim 11, wherein:
the first connector is fixedly attached to the first riser, and
the second connector is fixedly attached to the second riser.
